(19) United States
(12) Patent Application Publication
(10) Pub. No.: US 2003/0121058 A1
(43) Pub. Date: Jun. 26, 2003

(54) Personal adaptive memory system

(76) Inventors: Nevenka Dimitrova, Yorktown Heights, NY (US); Angel Janevski, New York, NY (US)

Correspondence Address: PHILIPS ELECTRONICS NORTH AMERICAN CORP, 580 WHITE PLAINS RD, TARRYTOWN, NY, 10591, US

(21) Appl. No.: 10/028,299

(22) Filed: Dec. 24, 2001

(51) Int. Cl. H04N 7/173; H04N 7/16

(52) U.S. Cl. 725/134; 725/110; 725/9

(57) ABSTRACT

An adaptive memory system remembers facts, e.g. names the user has asked for, and the depth of information a user has requested on a certain topic. The adaptive memory builds a data structure of the user's knowledge base and behavior. The system applies this knowledge when retrieving segments of interests, augmenting video programs, recommending new programs. Also the system can use this knowledge and select items for a personal TV channel.

### RELATED APPLICATIONS

The following patent and applications are incorporated herein by reference

U.S. patent application Ser. No. 09/442,960 filed Nov. 18, 1999 by Dimitrova et al. in, entitled “Method and Apparatus for Audio/Data/Visual Information Selection” (PHA 23,847);

U.S. Pat. No. 6,137,544 and issued Oct. 24, 2000 to Dimitrova et al., entitled “Significant Scene Cut Detection And Frame Filtering For a Visual Indexing System”;

U.S. patent application Ser. No. 09/818,303 filed a Mar. 27, 2001 by Dimitrova et al. entitled “Automatic Video Retriever Genie” (US010079);

U.S. patent application Ser. No. 09/370,931 filed Aug. 9, 1999 by Agnihotri et al. entitled “System And Method For Analyzing Video Content Using Detected Text In Video Frames”;

U.S. patent application Ser. No. 09/351,086 filed Jul. 9, 1999 by Dimitrova entitled “Method and Apparatus for Linking a Video Segment to Another Video Segment or Information Source”;

U.S. patent application Ser. No. 09/372,959 filed Aug. 12, 1999 by Schaffer entitled “Customizing Database Information Presentation with Media Selections”

U.S. patent application Ser. No. 09/712,681 filed Nov. 14, 2000 by Agnihotri et al. entitled “Method and Apparatus for the Summarization and Indexing of Video Programs Using Transcript Information” (US 000279)

### BACKGROUND OF THE INVENTION

A. Field of the Invention

The invention relates to the field of interactive experiencing of multimedia content.

B. Related Art

The present application is an improvement upon U.S. patent application Ser. No. 09/442,960 filed Nov. 18, 1999. That application showed a video content analysis classifying visual, audio, text, and meta-data. The results of the analysis were used for searching for developing a user profile based on user behaviors and recommending additional content. However, the types of data acquired and used for recommendations were limited including such things as genre preferences and records of what the user has watched.

### SUMMARY OF THE INVENTION

It would be advantageous to better analyze the data from experienced content in order to derive there from higher level facts.

Advantageously, a data processing system is designed to effect a personal adaptive memory. The personal adaptive memory will include personal and preference data that will include facts extracted from experienced content and facts extracted from user behavior.

Preferably the facts will be of a sort that mimics human memory and knowledge about life experiences. The system can use such an adaptive memory to generate intelligent queries to gather additional content; recommend content; and/or obtain augmented content.

The system also maintains the adaptive memory on an ongoing basis by monitoring content experienced by the user and user behaviors and updating the memory accordingly.

Objects and advantages will be apparent in the following.

### BRIEF DESCRIPTION OF THE DRAWING

The invention will now be described by way of non-limiting example with reference to the following drawings.

FIG. 1 shows a system in which the invention can be used.

FIG. 2 shows a portion of the inside of the set-top box 101.

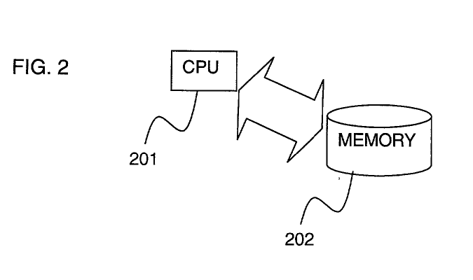

FIG. 3 shows a high-level flowchart of the operation of the invention.

FIG. 4 is a data flow diagram about the operation of the invention.

FIG. 5 shows a data structure for use in the invention.

### DETAILED DESCRIPTION OF THE PREFERRED EMBODIMENTS

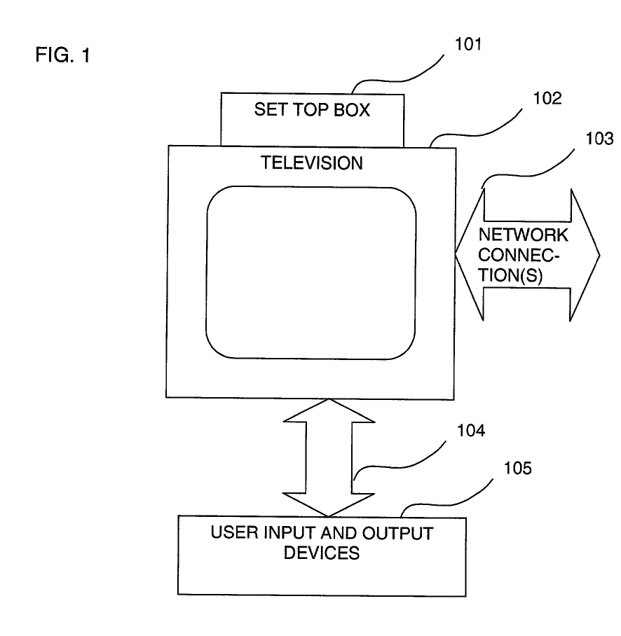

FIG. 1 shows a system for interactively experiencing multimedia information. The system includes a set-top box 101, a television 102, network connections 103, user communication channels 104, and user input and output (I/O) devices 105.

The system is illustrated as including a television 102 and a set-top box 101. The system preferably has some processing capability such as an advanced set top box complete with storage. Alternatively, a PC and monitor could be used in place of the television and set top box—or any other suitable type of processing. Normally, this system will include at least one local memory 202 and at least one central processing unit (CPU) 201. The processor and memory may be of any suitable type. For instance, the processor may be a digital signal processor. However the system may also make use of remote processing and memory facilities. The memory can be used for storing code and/or data. The processor 201 can execute operations specified by such code or specified remotely.

The network connections 103 may include one or more of: an antenna coupled to receive programming from a terrestrial broadcast network; a television cable connection; an Internet connection; a telephone network type connection; a local area network (LAN), or any other suitable network connection. The I/O devices 105 may include one or more of: a keyboard, a remote, a pointer device (such as a joystick, mouse, track ball, touchpad, etc.), a printer, or any other suitable user input or output device. The user I/O devices 105 may also include security devices for detecting the user, such as a camera, an ID tag sensor, or a fingerprint sensor.

An adaptive memory system in accordance with the invention can remembers facts derived from experienced content, e.g. names the user has asked for, the depth of information a user has requested on a certain topic, and summaries and analysis all derived from experienced content. The adaptive memory builds a data structure that mimics the user's knowledge base and behavior by storing high level information.

For example, a user will not remember a movie in detail. Instead, the user will remember certain facts such as plot summaries, names of actors, and scenery. The user will typically then seek out other content that may be inspired by what he or she enjoyed or did not enjoy in the movie. Similarly, the adaptive memory system uses its facts derived from experienced content when retrieving segments of interests, augmenting video programs, and recommending new programs. Also the system can use this knowledge and select items for a personal TV channel.

As used herein, the term “content” can include any type of content, such as multimedia, video, audio, and text. Content may be a “program” produced by an external source or a combination of programming and augmented content assembled locally to the user.

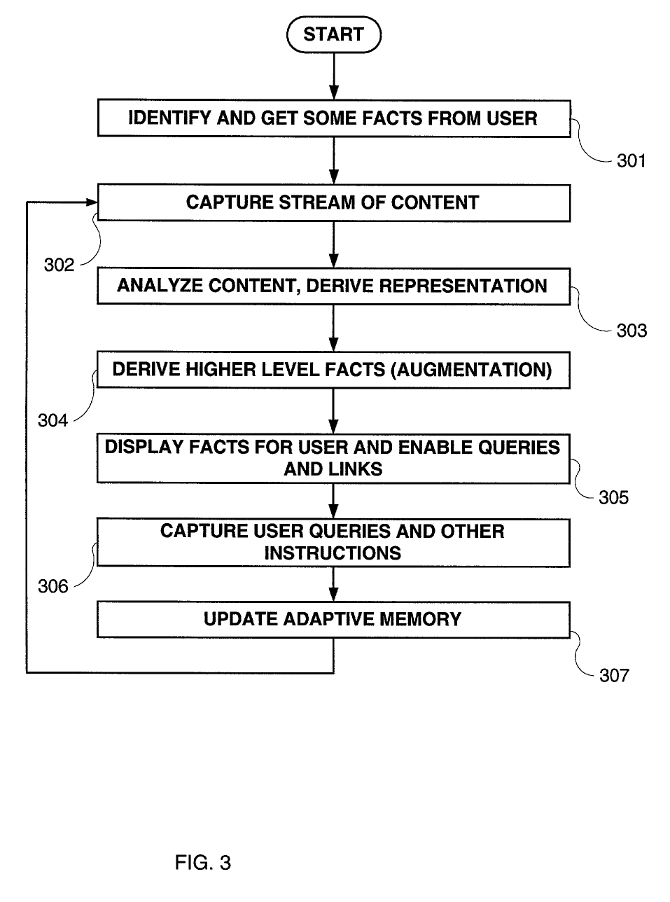

FIG. 3 shows a simplified flowchart of the operation of the invention.

Initially, at 301, the system identifies the user and collects some information. Step 301 will not be executed frequently—normally only for a new user or in response to explicit changes from the user.

While the example is given in terms of a single user, the system may maintain respective adaptive memories for each of several users. Separate files would have to be maintained for user behaviors for each user; but if more than one of the users had experienced the same content, summaries or facts extracted from that content might be shared between those users.

Personal information might include one or more of: name, number of children, marital status, assets, car, house, personal possessions, Internet favorite URLs, income, ethnic group, sex, age, or any other potentially useful statistical or demographic information—for example

Age: 35, Ethnic background: Macedonian/Slavic; Family: Maried/4 children, Income: $55555, Cars: 2; Houses: 1; Personal items list: Palm pilot (w/IP address), work PC (w/IP address), personal Web site (www.mypersonalwebsite.com).

Content preferences may be collected; both as related to genre of content and what performers, directors, or writers the user prefers—for example:

News: local (Westchester), international (Europe)

Narrative: Comedy, Drama, Documentary (travel, WWII)

The system may also prompt the user to specify storage preferences, such as number of episodes, old vs. new content, how long to store information—for example

Store up to 5 programs of reruns and store new content until space needed Store movies up to 10 days, News up to 2 days

The system may further request augmentation preferences, such as the degree of augmentation, recommended per content types, or specific content—for example

News: Matched story=High, Weaker match stories=Medium

Movies: Low

Documentaries: High

Other interests of the user may also be recorded, such as profession, hobbies, places traveled to, desired future travel locations, music preferences, links to the user's music collections and listening history, or intellectual subjects such as politics, history, geography, particular events, economies, technology—for example

politics—current and past events, regions

Regions: US, Europe

Events: WWII, Yugoslavia wars, MMF

history—

WWII, Europe, Roman Empire

economy—

IT Industry, DOW, NASDAQ, Philips quote, Vanguard quote

technology—

Auto Industry, Computer technologies, Communications

. . .

The system may also inquire into religious or value preferences of the user.

Then, at 302, a stream of content experienced by the user is captured. This stream of content would include both a content history and an interaction history.

The content is analyzed at 303 and an internal representation is derived. At 304, higher level facts are derived.

At 305, the higher level facts are displayed for the user in such a way as to enable links and queries.

At 306, user queries and other interactions are captured. The information captured at 306 could include a history of the user's interaction with the content, e.g. level of interest, intensity, requested augmentation, deletions without watching, or recommendations to others.

At 307 the adaptive memory is updated. This updating will use the results of box 306 and data extracted at 304. The updating preferably includes “snapshots.” More about snapshots will appear in the section entitled “Snapshots,” below.

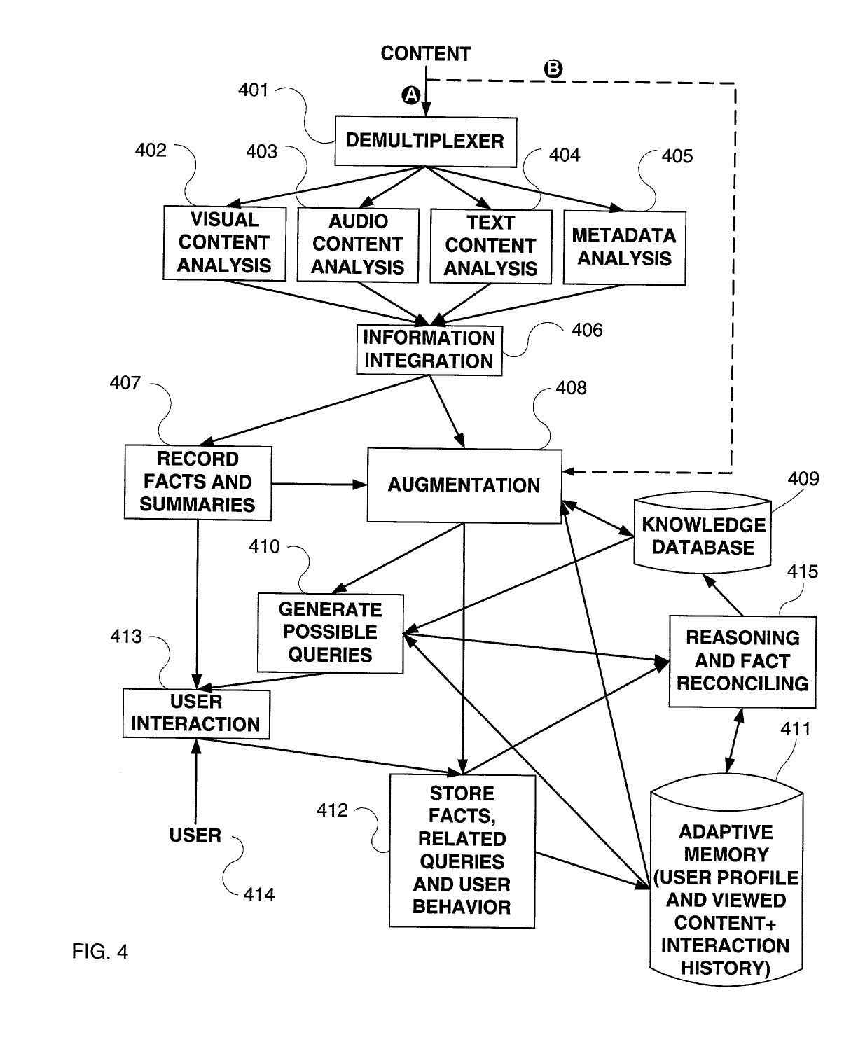

FIG. 4 shows data flow during the operation of the invention. This view also shows how more operations can proceed in parallel, rather than sequentially.

At 401 an MPEG type demultiplexer demultiplexes content into data components such as visual, audio, text, and metadata.

Visual content is analyzed at 402. Examples of such analysis are given in U.S. Pat. No. 6,137,544 issued to Dimitrova et al. Oct. 24, 2000, entitled “Significant Scene Cut Detection and Frame Filtering for a Visual Indexing System”, and EP 1066577 A1 by Agnihotri et al., entitled “System and Method for Analyzing Video Content Using Detected Text in Video Frames” Published Aug. 3, 2000, which is a counterpart of U.S. patent application Ser. No. 09/370,931 filed Aug. 9, 1999. The result of such analysis will be a classification of visual information experienced by the user.

At 403, audio content is analyzed. An example of such analysis can be found in Li et al., “Classification of General Audio Data for Content-Based Retrieval”, Pattern Recognition Letters 2001. The result of such analysis will be a classification of audio information experienced by the user.

At 404, text content is analyzed. An example of such text content analysis can be found in U.S. patent application Ser. No. 09/712,681 filed Nov. 14, 2000 by Agnihotri et al. entitled “Method and Apparatus for the Summarization and Indexing of Video Programs Using Transcript Information” (US 000279);

At 405, metadata, such as electronic program guide information and genre information, are analyzed.

All of the combined analyses are integrated at 406. An example of such integration is found in U.S. patent application Ser. No. 09/442,960 filed Nov. 18, 1999 by Dimitrova et al., entitled “Method and Apparatus for Audio/Data/Visual Information Selection”.

At 407, higher level facts and summaries—such as name of actor, historical setting, and other salient details—are extracted and recorded for later use.

At 408, augmented content is sought out, and possible queries are generated at 410. An example of how boxes 408 and 410 can be realized is in U.S. patent application Ser. No. 09/818,303 filed a Mar. 27, 2001 by Dimitrova et al. entitled “Automatic Video Retriever Genie” (US010079). More about queries and the operations of box 410 can be found in the section entitled “Query generation,” below.

Seeking out augmented content requires the facts and summaries which were recorded at 407, facts from the knowledge database 409, and information from the adaptive memory 411. This latter knowledge database 409 will preferably be knowledge which is encyclopedic in scope, and may initially be acquired by commercial sources though it may be updated by the local system.

At 413, responsive to the fact extraction at 407 and the queries at 410, the user 414 generates user interactions. At 412, facts, related queries, and user behavior are captured responsive to box 413 and responsive to the augmentation at 408.

User behaviors will typically include play sequence commands, such as fast forward, pause, replay, jump, select, and rewind. These play sequence commands indicate the level of interest a user has in material. Each play sequence command can be assigned an interest level value, which can be used in calculating the user's interest in a particular content segment.

Another user behavior is merely the user's presence or absence during a piece of content. There are a variety of systems that can detect viewers in front of the screen, and even recognize them visually, e.g. a video camera with appropriate software. Other user detection techniques could use ID tags on clothing or accessories, fingerprints on a remote control, etc. Whether a user was actually present during the playing of the content is preferably recorded as a measure of degree of the user's interest.

In the preferred embodiment, all the knowledge about the user preferences, viewing history and interaction history is stored in a database at 411 and represented as facts, i.e. predicates, where each row is treated as an assertion. These facts are used to feed the augmentation box 408 and the possible queries box 410.

Box 415 uses reasoning and fact reconciling to clean up and reorganize the facts in the is adaptive memory 411, especially logic reasoning. This type of reasoning assigns true or false as predicates to facts. For instance, “birds fly” would be stored along with the predicate “true”. Therefore on hearing “Tweety is a bird”, the logic system should conclude that Tweety can fly. However, if the logic system knows that Tweety is a penguin, then the system should make an exception because penguins don't fly.

In general, the system must find ways resolving apparent contradictions between facts. For instance, certain countries may be recorded as being part of the USSR or Yugoslavia; but that may have stopped being true. Box 415 takes care of these problems.

Preferably, the search model of box 415 relies on a non-monotonic logic system that uses the represented facts in order to derive inferences and answer questions about the stored facts. The types of non-monotonic logic that can be used include: default logic, circumscription, default theory, modal theories. For more information on these types of logic, please see Jack Minker, “An Overview of Nonmonotonic Reasoning and Logic Programming,” Journal of Logic Programming 17(2/3&4): 95-126 (1993)).

A popular search technique that can be used is the large scale knowledge system, CYC, which uses default logic for reasoning. A description of CYC can be found in: Lenat, D. B. (1995). “Cyc: A Large-Scale Investment In Knowledge Infrastructure,” Communications of the ACM, 38 (11). 1995, and the items listed in the bibliography thereof.

However, modal logic is preferable for reasoning and making queries. Modal logic introduces a modal operator, M, into first order logic. If p is a sentence in first order logic, then Mp denotes the sentence in modal logic whose intended meaning is “p is consistent with what is known,” or “maybe p”. In addition to autoepistemic logic, a further extension is used in which instead of a “maybe” operator a “necessarily” modal operator L is substituted. Intuitively, Lp is to be read as “I know p.” This is a model of an ideally rational agent's reasoning about its own beliefs. This is further developed in V. Lifschitz, “Nonmonotonic Databases and Epistemic Queries: Preliminary report”, proceedings of 12^{th} International Joint Conference on Artificial Intelligence, pp. 381-386, Sydney, Australia, 1991. This paper brings together formalism to deal with epistemic queries in the context of default queries and circumscriptive theory. His formalism gives meaning to epistemic queries in the context of logic programming (applied to databases) and can ask queries such as: “What does the system know?” This is related to query evaluation in databases that are treated as first order formulas that also contain an epistemic modal operator and work in epistemic formulae used in knowledge representation for expressing defaults.

In this formalism, if “K” is the modal operator, Kp means “I know p” and implies that that is all I know. So, if a data base contains the assertions p (where p=professor(mcCarty) and q (where q=flies(Tweety)), then all the data base facts that are known are p, q, and their tautological consequences. In addition, many non base facts are known such as that “we don't know r” [symbol] Kr (where r=president(Bush)). This is a non-monotonic property: if r is added to the database after the election, then Kr is true, and therefore [symbol] Kr is no longer known. With respect to the queries, one can ask if John teaches any classes this semester with a formula: [symbol] x teaches(John,x)). In addition, the system can ask whether there is a known class that John teaches, by the epistemic formula: [symbol] x K teaches(John,x)). The major difference between these queries becomes essential when the database contains incomplete (for instance, disjunctive) information.

Entries can be deleted due to

expiration, which happens when entries have not been used for a long period and their rating puts them at the bottom (i.e. the memory “forgets” these entries)

garbage collection, where the memory eliminates them due to a new entry that better embeds the information in the eliminated entry, or when the memory realizes that the entry (for example due to a wrong derivation of a conclusion) is mistakenly present in the memory.

Entry deletion is likely to trigger a chain of reevaluations that may result in updates and/or other deletions, which are also handled by box 415.

Box 415 can also be used to update the knowledge database 409.

Moreover, Box 410 can use modal logic, analogously to box 415, to generate possible queries.

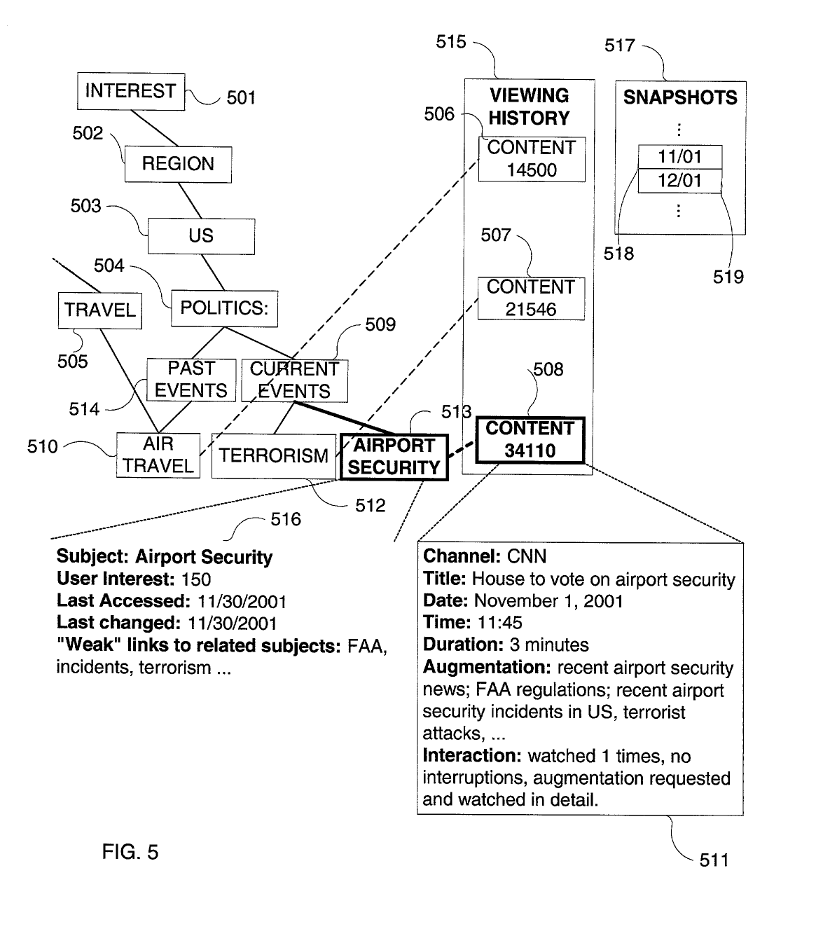

FIG. 5 shows operation of the adaptive memory. This memory preferably stores data such as the following:

Collection of viewed/stored content (actually metadata describing it, including user's interaction with the content: interest intensity, request augmentation, delete, recommend)

News: CNN—House to vote on airport security

Nov. 1, 2001 (11:45, 3 minutes)

Augmentation: recent airport security news; FAA regulations; recent airport security incidents in US

Interaction: watched 1 times, no interruptions, augmentation requested and watched in detail.

Movie: Austin Powers—International Man of Mystery

Oct. 29, 2001 (20:00, 2 hours)

Augmentation: James Bond movies; Mike Myers; Jaguar cars; and summaries of James Bond movies

Interaction: watched 1 times, 3 pauses, 1 fast-forward, augmentation requested and (⅔ augmentations) watched in detail.

Collection of content augmentations (linked to more than one piece of content)

recent airport security news (linked to numerous news from the attacks on America); tagged: US, politics, terrorism, crime

FAA regulations (linked to one entry/from above/) US, air travel, terrorism, crime

recent airport security incidents in US (linked to numerous news from the attacks on America) tagged: travel, US, politics, terrorism, crime

James Bond (linked to Austin Powers set of James Bond movies the user has seen); tagged: fictional (novel) character, adventure, espionage, fiction

Mike Myers (linked to Austin Powers and several other Austin Powers movies the user has seen, and Saturday Night Live shows in the viewing history); tagged: person, actor, comedian

Jaguar cars: (linked to Austin Powers and other movies and documentaries), tagged: object, vehicle, prestigious.

Collection of higher level entities derived from the previous two content examples.

‘US airport security’ related-to ‘terrorism’

‘US airport security’ is-a (top current issue)

‘James Bond’ related-to ‘Austin Powers’

‘Austin Powers’ is-a (James Bond parody)

. . .

Periodic ‘snapshots’ of users top interest at a time (or for a period between snapshots).

October 2001: News: 30% (augmentation 70%), Movies 50% (augmentation 10%), Documentaries 20% (augmentation 20%).

The data is preferably stored in a data structure including linked indexing nodes. The indexing nodes may reflect various subject matters. Illustrated are several linked nodes: interest 501, region 502, U.S. 503, politics 504, past events 514, current events 509, travel 505, air travel 510, and terrorism 512. A new node, airport security 513, is being added. Preferably, for ease of searching, the linked data structures reflect a hierarchy of subject matters. Thus region 502 is a subcategory of interest 501; U.S. 503 is a subcategory of region 502; politics 504 is a subcategory of U.S. 503; past events 514 and current events 509 are both subcategories of politics 504; air travel is a subcategory of both past events 514 and travel 505; terrorism 512 and airport security 513 are both subcategories of current events 509.

In general, each node within the adaptive memory can be reached by several paths, because any one piece of information may fit into several hierarchies.

Responsive to box 412, the adaptive memory is updated. Results of box 412 are illustrated as viewing history 515. The viewing history 515 contains locators for several content items, of which three are listed. Boxes 506, 507, and 508 contain content with content locator IDs 14500, 21546, and 34110, respectively, for use in the air travel, terrorism, and airport security categories, respectively. New content locators, in this case 34110, can be used as triggers for creating the new indexing nodes—in this case airport security category 513.

In the interests of conciseness, not all of the content of all of the nodes are shown. Only one update box 508 from the viewing history and only one indexing node 513 are expanded.

Locator 34110 points to the data illustrated in box 511, namely:

CNN-House to vote on airport security

Nov. 1, 2001 (11:45, 3 minutes)

Augmentation: recent airport security use; FAA regulations; recent airport security incidents in U.S.

Interaction: watched one time, no interruptions, augmentation requested and watched in detail.

The particular items in 511 (recent airport security news; FAA regulations; recent airport security incidents in US, terrorist attacks, . . . ) were chosen because of the story text. First, 406 and 407 extracted information and produced summary of the text. Then, 408 took this information and augmented relevant facts. For example, if FAA was mentioned, it found what FAA is in the context of the story; it also found ‘recent airport security incidents’, ‘terrorist attacks’ (this one could also be enforced by 411 because terrorism is already in the adaptive memory under recent news. In addition, this process would pick up names, political figures, company names, references to specific events (e.g. attacks on September 11). This process could also produce augmentation items that were not explicitly in the content. For example, although the text is not mentioning George Bush or bin Laden, they can also be part of the augmented content if there is a strong match in 411 or 409. In general, those of ordinary skill in the art, in implementing logic reasoning will devise systems that may make the same or different selections from experienced content.

In order to reflect the update of boxes 508, an indexing node 513 is created to link to the is locator 34110 within box 508. This node 513, called “airport security,” is expanded at 516. Each indexing node will preferably have the same fields, but, as explained above, only one such indexing node is expanded. In this example, the fields are subject, user interest, last access date, last changed date, and weak links. The weak links are links other than those within the hierarchy of the tree that is shown. Those of ordinary skill in the art can readily design other node structures which are usable in an adaptive memory in accordance with the invention. The values of the field in the node for airport security are as follows

| FIELD | VALUE |
|---|---|
| Subject | Airport security |
| User interest | 150 |
| Last access date | Nov. 30, 2001 |
| Last changed date | Nov. 30, 2001 |
| Weak links | FAA, incidents, terrorism |

Similarly, as part of the update of the adaptive memory with the new content, box 506 is linked to box 510 and box 507 is linked to box 512. In general, all the indexing nodes: 501, 502, 503, 504, 514, 509, 510, 512, 513, and those not shown, will have multiple links leading to various content nodes. For brevity, only the three content nodes 506, 507, and 508 are shown, but in reality there would be many, many more.

While FIG. 5 has been illustrated with a particular data structure, those of ordinary skill in the art can readily devise alternative data structures, which can function within the adaptive memory. Other categories and subcategories may be devised by the skilled artisan in addition to and/or alternatively to those illustrated.

Query Generation

More information about how to generate queries, per box 410, can be found in U.S. patent application Ser. No. 09/818,303 filed a Mar. 27, 2001 by Dimitrova et al. entitled “Automatic Video Retriever Genie” (US010079).

The example of FIG. 5 shows at 508 that the system extracted the following information from the content segment:

Channel: CNN

Title: House to vote on airport security

Date: Nov. 1, 2001

Time: 11:45

Duration: 3 minutes

Augmentation: recent airport security news; FAA regulations; recent airport security incidents in US, terrorist attacks, . . .

Interaction: watched 1 times, no interruptions, augmentation requested and watched in detail.

In addition, the system has information about the genre of the content, production date (e.g. year), summary and similar details provided for example by the EPG entry.

The system generates W-queries: Who, where, when, what, when. In addition, the system could generate queries such as “Tell me more about X” and “Where was Y last mentioned in the content I saw earlier”.

Names from the story are used to generate Who queries—for example, who is George Bush. Names of places are used to generate Where and What queries, events are used to generate When and What queries all in accordance with the incorporated art.

From the augmentation data, the system is able to add queries on facts, people and events that are not explicitly mentioned in the story. For example, terrorist attacks may not be mentioned in the content—but because of earlier augmentations and content segments the system has established a link between airports, airport incidents and terrorism. In addition, the user showed a lot of interest in these topics. Therefore, one question that may be answerable/generated from this story can be “Tell me more about recent airport security incidents”.

Snapshots

Parts of what goes into the updated memory at 307 are “snapshots” of patterns, as illustrated at 517. Snapshots are preferably taken about once a month, as a type of background processing. Here a November 2001 snapshot is shown at 518 and a December 2001 snapshot is shown at 519. A snapshot is a collection of general knowledge entities pointed to by the most popular entries in the memory. Snapshots could also be groups of entities, such as documentaries. The snapshots function as a kind of history, as indicators of trends, and as a higher level view of user behavior. They are used as a bias on the system.

Many attributes are used to rank topics found in a story and its augmentation.

The main source is the topic relation network (as illustrated in FIG. 5) which can immediately provide a set of topics. In addition, the “weak” links can provide a secondary set of topics that can be used for additional augmentation and/or query generation. Furthermore, the adaptive memory snapshots can provide additional criteria to rank all topics.

For example, if the user watched news 60% of the time in the last period of time and also interacted with the content frequently, topics that are directly related to news will receive additional boost in the ranking process. Snapshots capture user behavior over higher-level topic groups such as news, politics, history (usually genre-based, but could be defined in another fashion as well).

Since snapshots are preserved in the system, behavior tendencies can be deduced when comparing series of snapshots. For example, if there is a high increase in news content, the system could deduce that something dramatically important is happening and “push” more news content on the user. Alternatively, if there is a rise in narrative content interest (movies, sitcoms) or genre preference (for example comedy), the system may push more entertaining content.

From reading the present disclosure, other modifications will be apparent to persons skilled in the art. Such modifications may involve other features which are already known in the design, manufacture and use of user profiling and content analysis and which may be used instead of or in addition to features already described herein. Although claims have been formulated in this application to particular combinations of features, it should be understood that the scope of the disclosure of the present application also includes any novel feature or novel combination of features disclosed herein either explicitly or implicitly or any generalization thereof, whether or not it mitigates any or all of the same technical problems as does the present invention. The applicants hereby give notice that new claims may be formulated to such features during the prosecution of the present application or any further application derived therefrom.

The word “comprising”, “comprise”, or “comprises” as used herein should not be viewed as excluding additional elements. The singular article “a” or “an” as used herein should not be viewed as excluding a plurality of elements.

We claim:

1. A medium readable by a data processing device and embodying at least one adaptive personal memory comprising embodiments of:
personal information;
facts derived from content experienced by at least one relevant user; and
facts derived from the relevant user's behavior

2. The medium of claim 1, wherein the facts derived from content comprise a name of at least one person who participated in creation of a relevant piece of content.

3. The medium of claim 1, wherein the facts derived from content comprise a summary of a relevant piece of content.

4. The medium of claim 1, wherein the data structures comprise a hierarchy of linked index nodes, wherein each index node corresponds to a subcategory of information.

5. The medium of claim 4, wherein each index node in the hierarchy comprises at least one link to a content node and at least one field for storing weak links to other index nodes, which weak links do not fit into the hierarchy.

6. The medium of claim 1, wherein the facts derived from user behaviors include at least one record of play sequence commands.

7. The medium of claim 1, wherein the facts derived from user behaviors include at least one record of presence or absence of the user,

8. The medium of claim 1, wherein the facts derived from user behaviors include at least one record of queries.

9. The medium of claim 1, wherein adaptive personal memory includes at least one snapshot, which snapshot data acts as a bias toward a longer term view of user behavior.

10. A data processing system comprising:
at least one medium according to claim 1;
at least one processor adapted to perform operations to make the medium into a personal adaptive memory, the operations including the following:
maintaining adaptive personal memory embodied in the medium;
capturing content experienced by the relevant user and the relevant user's behaviors;
analyzing the content and behaviors to create updated data; and
updating the adaptive personal memory embodied in the medium with the updated data.

11. The system of claim 10, wherein the operations further comprise interfacing with the relevant user responsive to the adaptive personal memory and to acquire more data from the relevant user.

12. The system of claim 11, wherein interfacing further comprises one or more of
retrieving segments of interest from an external source based on the adaptive personal memory;
augmenting video programs based on the adaptive personal memory;
recommending new content based on the adaptive personal memory; and
creating a personal television channel based on the adaptive personal memory.

13. The system of claim 10, wherein analyzing user behaviors includes determining a level of interest in particular content, responsive to one or more of:
whether or not the content was viewed in detail;
what play sequence commands occurred; and
what queries were made.

14. The system of claim 10, wherein analyzing comprises using snapshot data as a bias toward a longer term view of user behavior.

15. The system of claim 10, wherein at least one of the maintaining, analyzing, and updating steps makes use of non-monotonic logic.

16. The system of claim 15, wherein the non-monotonic logic is modal logic.

17. A data processing system comprising
the medium of claim 1;
at least one processor adapted to perform operations including
maintaining the medium as a personal adaptive memory in accordance with ongoing user behaviors and content experience; and
forming at least one query, responsive to the adaptive memory, for one or more of: gathering additional content; recommending content; augmenting content; and creating a personal television channel.

18. The system of claim 17, wherein the query comprises seeking out new content having a participant in common with previously experienced content.

19. The system of claim 17, wherein the query comprises seeking out new content having summary information in common with previously experienced content.

20. The system of claim 17, wherein the forming comprises using snapshots as a bias toward a longer term view of user behavior.

21. The system of claim 17, wherein the forming comprises use of non-monotonic logic.

22. The system of claim 17, wherein the non-monotonic logic comprises modal logic.

23. A data processing method comprising executing at least the following operations in a data processing device:
maintaining at least one adaptive personal memory including:
personal information;
facts derived from content experienced by at least one relevant user; and
facts derived from the relevant user's behavior.

24. The method of claim 23, wherein facts derived from the relevant user's behavior include a record of one or more of
play sequence commands;
presence or absence of the user; and
queries.

25. The method of claim 23, wherein the adaptive personal memory comprises at least some current data and at least some snapshot data, which snapshot data acts as a bias toward a longer term view of user behavior.

26. The method of claim 23 wherein the operations further comprise
capturing content and summaries experienced by the relevant user and the relevant user's behaviors;
analyzing the content and behaviors to create updated personal data;
updating the adaptive memory with the updated personal data.

27. The method of claim 26, wherein the operations further comprise interfacing with the relevant user responsive to the adaptive personal memory and to acquire more data from the relevant user.

28. The method of claim 26, wherein at least one of the maintaining, analyzing, and updating steps makes use of non-monotonic logic.

29. The method of claim 28, wherein the non-monotonic logic is modal logic.

30. The method of claim 26, wherein the operations further comprise forming at least one query, responsive to the adaptive memory, for one or more of: gathering additional content; recommending content; augmenting content, and creating a personal television channel.

31. The method of claim 30, wherein forming includes use of non-monotonic logic.

32. The method of claim 31, wherein the non-monotonic logic includes modal logic.

33. The method of claim 32, wherein the forming comprises using snapshots as a bias toward a longer term view of user behavior.

34. At least one medium readable by at least one data processing device and embodying code for causing the data processing device to perform operations comprising:
maintaining at least one adaptive personal memory including:
personal information;
facts derived from content experienced by at least one relevant user; and
facts derived from the relevant user's behavior.

35. The medium of claim 34, wherein facts derived from the relevant user's behavior include a record of one or more of
play sequence commands;
presence or absence of the user; and
queries.

36. The medium of claim 34, wherein the adaptive personal memory comprises at least some current data and at least some snapshot data, which snapshot data acts as a bias toward a longer term view of user behavior.

37. The method of claim 34 wherein the operations further comprise
capturing content and summaries experienced by the relevant user and the relevant user's behaviors;
analyzing the content and behaviors to create updated personal data;
updating the adaptive memory with the updated personal data.

38. The medium of claim 34, wherein the operations further comprise interfacing with the relevant user responsive to the adaptive personal memory and to acquire more data from the relevant user.

39. The medium of claim 34, wherein at least one of the maintaining, analyzing, and updating steps makes use of non-monotonic logic.

40. The medium of claim 39, wherein the non-monotonic logic includes modal logic.

41. The medium of claim 34, wherein the operations further comprise forming at least one query, responsive to the adaptive memory, for one or more of: gathering additional content; recommending content; augmenting content, and creating a personal television channel.

42. The medium of claim 41, wherein forming includes use of non-monotonic logic.

43. The medium of claim 41, wherein the non-monotonic logic includes modal logic.

44. The medium of claim 42, wherein the forming comprises using snapshots as a bias toward a longer term view of user behavior.
